(19) United States
(12) Patent Application Publication
(10) Pub. No.: US 2011/0215281 A1
(43) Pub. Date: Sep. 8, 2011

(54) METHOD FOR PREPARING CIGS INKS WITHOUT SURFACTANT

(75) Inventor: Uen-Ren Chen, Taoyuan (TW)

(73) Assignee: JENN FENG NEW ENERGY CO., LTD, Taoyuan (TW)

(21) Appl. No.: 12/716,405

(22) Filed: Mar. 3, 2010

(51) Int. Cl. H01B 1/02

(52) U.S. Cl. 252/519.4

(57) ABSTRACT

A method for preparing a CIGS ink without a surfactant or a binder is provided. In accordance with the method of the present invention, an initial CIGS mixture powder is obtained by mixing two component powder, three component powder or four component powder of copper, indium, gallium, and selenium in predetermined proportions. Then additional selenide powder is added and mixed into the initial CIGS mixture powder to form a final CIGS mixture powder. Then, a certain proportion of solvent is added into the final CIGS mixture powder, and the mixture powder is then stirred to obtain a CIGS ink in a predetermined copper/indium/gallium/selenium ratio as desired.

### BACKGROUND OF THE INVENTION

1. Field of the Invention

The present invention relates generally to a method for preparing a copper-indium-gallium-selenide (CIGS) ink, and more particularly, to a method for preparing CIGS inks without a surfactant or a binder.

2. The Prior Arts

Recently, with rising gasoline price and the global trend in green energy, many governments worldwide pay more attention to renewable energy. In the future, the solar energy is expected to take a much more important position in all energies used by human beings. Solar cells are designed to turn solar irradiance, which will never be exhausted, into electricity. As such, many countries have allocated a lot of funds and subsidies for policy considerations in developing solar cells technology and cultivating local solar cell industries. Accordingly, the global solar cell industry is being fast developed.

The first generation of solar modules includes monocrystalline silicon and polysilicon solar modules. They win the higher market share due to the high photoelectric conversion efficiency. However, the price variation of the silicone wafers is too high to approach grid parity. Accordingly, the second generation of thin film solar modules including amorphous silicon (α-Si), copper indium gallium selenide (CIGS), and cadmium telluride (CdTe), has been recently developed. Among them, CIGS thin film solar cells, having the highest photoelectric conversion efficiency (a small cell unit reaches to 20%, and a solar module reaches to 14%), are particularly concerned.

Referring to FIG. 1, it is a schematic diagram illustrating a conventional CIGS solar cell structure. As shown in FIG. 1, the conventional CIGS solar cell structure includes a substrate 10, a first conductive layer 20, a CIGS absorbing layer 30, a buffer layer 40, a dielectric layer 50, and a second conductive layer 60. The substrate 10 can be a glass substrate, an aluminum substrate, a stainless steel substrate, or a plastic substrate. The first conductive layer 20 often includes molybdenum and serves as a back electrode. The CIGS absorbing layer 30 used for absorbing solar light includes copper, indium, gallium, and selenium in predetermined proportions and is p-type. The buffer layer 40, which is an n-type, includes cadmium sulfide (CdS). The dielectric layer 50 includes zinc oxide (ZnO) and is important to prevent shunting of the cell. The second conductive layer 60 includes zinc oxide doping aluminum (ZnO:Al) and serves as a window layer and a front electrode.

The conventional CIGS solar cell structure can be fabricated by either a vacuum process or a non-vacuum process depending on the processing method employed. In vacuum processes, evaporation method and sputtering method are generally used, and however, the expensive process equipments are requested and the efficiency of material utilization is low in vacuum processes. In the non-vacuum processes, the printing method and the electrodepositing method are generally used. Owing to the cheaper equipment investment and easier process tuning for manufacturing CIGS solar cell, the non-vacuum process has a good commercial potential for fabricating a large size of solar panel or module.

In a typical non-vacuum process of fabricating a CIGS absorbing layer, a CIGS slurry or ink is often prepared at first, and subsequently coated onto a molybdenum layer.

Referring to FIG. 2, there is shown a flow chart of a conventional method for preparing a CIGS ink. As shown in FIG. 2, starting at step S10, an initial mixture powder containing copper, indium, gallium, and selenide is obtained by mixing two component powder, three component powder or four component powder of copper, indium, gallium, and selenide in predetermined proportions. Then upon entering step S20, a certain proportion of solvent is added into the initial mixture powder, and the mixture is then stirred to obtain an initial CIGS ink. Finally, entering step S30, a binder or a surfactant, such as silane, is added into the initial CIGS ink for improving the adherence between the CIGS absorbing layer and the molybdenum back electrode, followed by stirring to obtain the CIGS ink.

However, in accordance with the foregoing conventional method for preparing the CIGS ink, residue of the binder or the surfactant may remain in the CIGS absorbing layer, so that the carbon content and oxygen content of the CIGS layer are relatively high. Unfortunately, high carbon content and oxygen content often adversely affect the light absorbing characteristic of the CIGS absorbing layer, and may even decrease the photoelectric conversion efficiency. As such, it is highly desired to develop a method for preparing a CIGS ink without a binder or a surfactant as a solution of the foregoing problem.

### SUMMARY OF THE INVENTION

A primary objective of the present invention is to provide a method for preparing a CIGS ink without a binder or a surfactant. In accordance with the method of the present invention, an initial CIGS mixture powder containing copper, indium, gallium, and selenide is obtained by mixing two component powder, three component powder or four component powder of copper, indium, gallium, and selenium in predetermined proportions. Then additional selenide powder is added and mixed into the initial CIGS mixture powder to form a final CIGS mixture powder. Then, a certain proportion of solvent is added into the final CIGS mixture powder, and the mixture powder is then stirred to obtain a CIGS ink with a predetermined copper/indium/gallium/selenium ratio as desired. In accordance with the method of the present invention, the additional selenide powder is used instead of the surfactant or the binder for providing a strong adherence between the CIGS absorbing layer and the molybdenum layer, while the selenium content in the CIGS absorbing layer remains unchanged (the selenium/copper ratio remains at about 2/1), and therefore the light absorbance of the CIGS absorbing layer and the photoelectric conversion efficiency would not be affected.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a conventional CIGS solar cell structure;

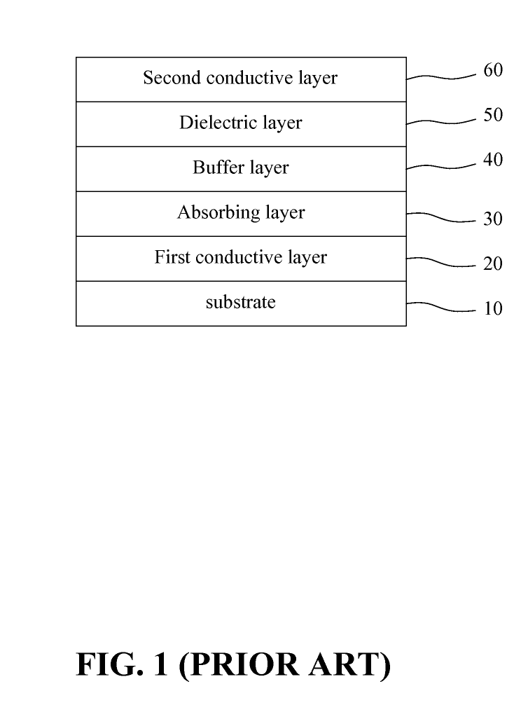

FIG. 2 is a flow chart showing a conventional method for preparing a CIGS ink; and

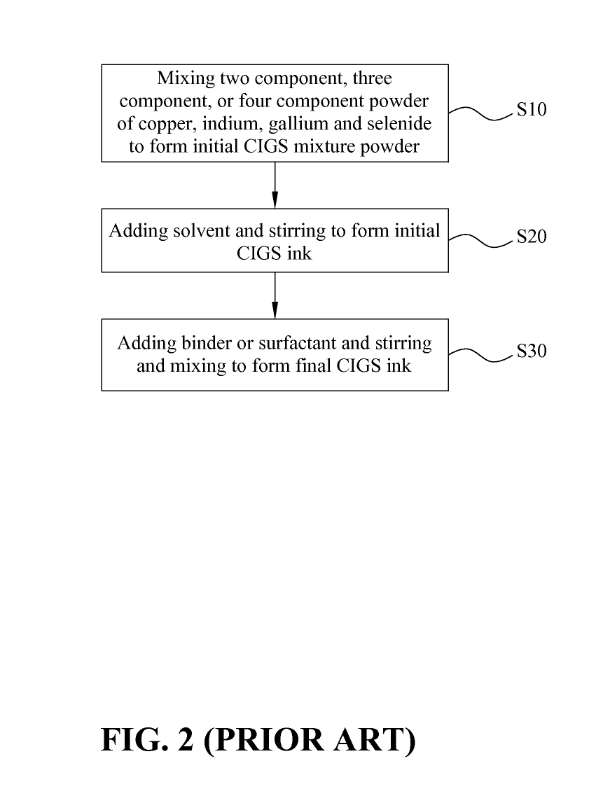

FIG. 3 is a flow chart showing a method for preparing a CIGS ink without a surfactant or a binder according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

The present invention provides a method for preparing a CIGS ink without a surfactant or a binder. In accordance with the method of the present invention, the CIGS ink prepared does not contain any surfactant or any binder which is often used in conventional CIGS ink for providing adherence between the CIGS absorbing layer and the molybdenum layer. The CIGS ink of the present invention without any surfactant or any binder is used for forming the CIGS absorbing layer on the molybdenum layer of a CIGS thin film solar cell structure.

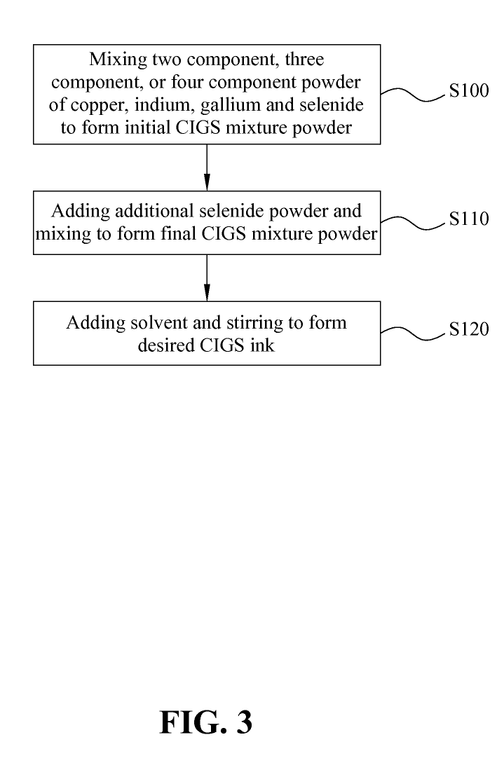

FIG. 3 is a flow chart showing a method for preparing a CIGS ink without a surfactant or a binder according to an embodiment of the present invention. Referring to FIG. 3, starting at step S100, the desired proportions of copper, indium, gallium, and selenium of the initial CIGS mixture powder are determined, and the initial CIGS mixture powder containing copper, indium, gallium, and selenium is obtained by mixing two component powder, three component powder or four component powder of copper, indium, gallium, and selenium. Then upon entering step S110, an additional selenide powder in a first selenide proportion is added and mixed into the initial CIGS mixture powder to form a final CIGS mixture powder, in which a selenium/copper ratio of the final CIGS mixture powder is raised up to more than 2. Finally, upon entering step S120, a certain proportion of solvent is added into the final CIGS mixture powder, and then the mixture powder is stirred to obtain a CIGS ink in a predetermined copper/indium/gallium/selenium ratio as desired.

In accordance with the method of the present invention, the additional selenide powder introduced in step S110 is used instead of the surfactant or the binder for providing strong adherence for adhering the CIGS absorbing layer to the molybdenum layer, so that the need of using a surfactant or a binder for adhering is eliminated.

Preferably, in the ink formula, the copper, indium, gallium, and selenium are mixed in a mole ratio of copper/indium/gallium/selenium=1.0/0.7/0.3/2.0. The additional selenide powder is added into the initial CIGS mixture powder to increase the content of selenium in the initial CIGS mixture, such that the mole ratio of copper/indium/gallium/selenium is changed to 1.0/0.7/0.3/X, where X is between 2.0 and 4.0. It should be noted that when the proportion of the additional selenide powder is too low, the desired adherence between CIGS absorbing layer and the molybdenum layer cannot be achieved, and when the proportion of the additional selenide powder is too high, the adherence between CIGS absorbing layer and the molybdenum layer also decreases. As such, in accordance with the present invention, the proportion of the additional selenide powder should be carefully controlled within the above range for achieving the objective of the present invention.

The substrate, for example, can be a glass substrate, an aluminum substrate, a stainless steel substrate, or a plastic substrate. The solvent, for example, includes at least one of DI water, alcohol, ethers, and ketone, or a mixture of at least two of them.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for preparing a copper-indium-gallium-selenide (CIGS) ink without a surfactant, which is used for forming a CIGS absorbing layer on a molybdenum layer on a substrate, the method comprising:
preparing an initial CIGS mixture powder by mixing two component powder, three component powder or four component powder of copper, indium, gallium, and selenium in predetermined proportions;
adding an additional selenide powder in a first selenide proportion into the initial CIGS mixture powder, and followed by mixing to obtain a final CIGS mixture powder; and
adding a solvent into the final CIGS mixture powder, and followed by stirring and mixing to obtain the CIGS ink.

2. The method according to claim 1, wherein the proportions of copper, indium, gallium, and selenium of the copper-indium-gallium-selenide (CIGS) ink are mixed in a mole ratio of copper/indium/gallium/selenium=1.0/0.7/0.3/2.0.

3. The method according to claim 1, wherein the additional selenide powder is added into the initial CIGS mixture powder to increase the selenium content in the initial CIGS mixture, such that the mole ratio of copper/indium/gallium/selenium is 1.0/0.7/0.3/X, where X is between 2.0 and 4.0.

4. The method according to claim 1, wherein the substrate is a glass substrate, an aluminum substrate, a stainless steel substrate, or a plastic substrate.

5. The method according to claim 1, wherein the solvent comprises at least one of DI water, alcohol, ethers, and ketone, or a mixture of at least two of DI water, alcohol, ethers, and ketone.
